(19) United States
(12) Patent Application Publication
(10) Pub. No.: US 2025/0162655 A1
(43) Pub. Date: May 22, 2025

(54) VEHICLE HOOD AND BRACKET

(71) Applicant: TOYOTA JIDOSHA KABUSHIKI KAISHA, Aichi-ken (JP)

(72) Inventor: Makoto OKUTSU, Toyota-shi (JP)

(21) Appl. No.: 18/943,898

(22) Filed: Nov. 12, 2024

(30) Foreign Application Priority Data
Nov. 16, 2023 (JP) 2023-194926

(51) Int. Cl. B62D 25/12

(52) U.S. Cl. CPC B62D 25/12

(57) ABSTRACT

A vehicle hood includes an outer panel, an inner panel, and a bracket. The bracket is a folded-plate member having a hat-shape cross section and including a web, two flanges rising from opposite ends of the web, and two arms respectively extending outward from corresponding upper edges of the respective flanges. The bracket is mounted on the inner panel such that each of the two arms faces the outer panel. The arm includes a protrusion having an inverted U-shape extending outward from the upper edge of the flange and an outer edge portion having a planar shape extending outward from an outward edge of the protrusion.

### CROSS REFERENCE TO RELATED APPLICATION

This application claims priority to Japanese Patent Application No. 2023-194926 filed on Nov. 16, 2023, which is incorporated herein by reference in its entirety including the specification, claims, drawings, and abstract.

### TECHNICAL FIELD

The present disclosure relates to a vehicle hood and to a structure of a bracket mounted within the vehicle hood.

### BACKGROUND

JP 2009-220726 A discloses a vehicle hood including a securing member having a lowered strength and disposed between an outer panel and an inner panel of the vehicle hood. This vehicle hood is configured to allow the securing member to break and absorb an impact load upon receiving an impact load from above the vehicle

JP 2016-22795 A discloses a structure that secures a vehicle pop-up hood device to a body through a shock absorber having a waveform plate shape. The structure disclosed in JP 2016-22795 A is configured to allow the shock absorber to break and absorb an impact energy upon the vehicular hood's receiving an impact load from above.

### SUMMARY

A vehicle hood includes an inner panel, to which a component may be fastened with a bolt or another fastener. In this configuration, part of the bolt may protrude from the inner panel toward the outer panel, and during pedestrian protection tests, a head impactor may come into contact with the protruding bolt. To address this deficiency, a structure has been studied in which a bracket having a hat-shape cross section is disposed in the vicinity of the bolt fastening portion. During the pedestrian protection tests, this structure allows the arm of the bracket to receive the head impactor, thereby preventing contact between the head impactor and the bolt.

During the pedestrian protection tests of the vehicle hood, impact of the head impactor may cause the outer panel of the vehicle hood to strongly interfere with an edge of the bracket. In this case, the edge of the bracket may rupture the outer panel and be exposed outward.

The present disclosure is therefore aimed toward preventing rupture of an outer panel during a pedestrian protection test of a vehicle hood.

In accordance with an aspect of the disclosure, a vehicle hood includes an outer panel, an inner panel, and a bracket disposed in a space between the outer panel and the inner panel. The bracket is a folded-plate member having a hat-shape cross section and including a web, two flanges rising from opposite ends of the web, and two arms respectively extending outward from corresponding upper edges of the respective flanges, and the bracket is mounted on the inner panel such that each of the two arms faces the outer panel. At least one of the two arms includes a protrusion having an inverted U-shape and extending outward from the upper edge of the corresponding flange, and an outer edge portion having a planar shape and extending outward from an outward edge of the protrusion.

This configuration allows a head impactor to come into contact with the protrusion of the bracket simultaneously with or prior to the head impactor contacting the outer edge portion of the bracket through the outer panel. The vehicle hood according to the present disclosure thus enables distribution of stress generated in the outer panel to thereby prevent rupture of the outer panel. The vehicle hood according to the present disclosure further enables prevention of exposure to the outside of an edge of the outer edge portion.

In the vehicle hood according to the disclosure, a tangent connecting a distal end of the outer edge portion and a face of the protrusion facing the outer panel may be substantially parallel to a direction in which the outer panel extends.

This configuration allows the head impactor to come into contact with the outer edge portion and the protrusion through the outer panel substantially simultaneously, to thereby enable distribution of the stress generated in the outer panel and inhibit rupture of the outer panel.

In the vehicle hood according to the disclosure, the outer edge portion may be inclined downward of a vehicle as the outer edge portion extends toward the distal end, and the outer edge portion may have an angle of inclination of greater than 0° and 40° or smaller.

This configuration allows the outer edge portion to be further diverted from the impacting direction, and enables further distribution of the stress generated in the outer panel contacting the outer edge portion to thereby prevent rupture of the outer panel.

In accordance with another aspect of the present disclosure, a bracket mounted within a vehicle hood includes a web, two flanges rising from opposite ends of the web, and two arms respectively extending outward from corresponding upper edges of the respective flanges, and the bracket is a folded-plate member having a hat-shape cross section. At least one of the two arms includes a protrusion having an inverted U-shape extending outward from the upper edge of the corresponding flange and an outer edge portion having a planar shape extending outward from an outward edge of the protrusion.

When an object directed toward the web hits the arm, the object hits the protrusion. This configuration can reduce a force of the object affecting the outer edge portion. Further, the two arms receiving the object prevent contact between the object and a bolt or other components disposed within the web.

The vehicle hood according to the present disclosure prevents rupture of the outer panel in a pedestrian protection test.

### BRIEF DESCRIPTION OF DRAWINGS

Embodiments of the present disclosure will be described based on the following figures, wherein:

FIG. 1 is an exploded perspective view illustrating a configuration of a vehicle hood according to an embodiment;

FIG. 2 is a perspective view illustrating a configuration of a bracket illustrated in FIG. 1;

FIG. 3 is a cross sectional view of the vehicle hood illustrated in FIG. 1 as viewed from forward of the vehicle, taken along A-A line in FIG. 1;

FIG. 4 is an explanatory view showing a state in which a head impactor enters the vehicle hood illustrated in FIG. 1 from above; and

FIG. 5 is a cross sectional view of a vehicle hood according to another embodiment, as viewed from forward of the vehicle.

### DESCRIPTION OF EMBODIMENTS

A vehicle hood 100 according to an embodiment will be described below by reference to the drawings. The vehicle hood 100 is disposed forward of a vehicle to cover a region above a front compartment accommodating a driving device, for example, and opens or closes the front compartment. In each drawing, symbols FR, UP, and RH denote frontward, upward, and rightward directions, respectively, of a vehicle including the vehicle hood 100. Directions opposite FR, UP, and RH indicate rearward, downward, and leftward, respectively. In the following description, simple description of the front-rear or longitudinal direction, the left-right or lateral direction, and the up-down or vertical direction refer to the front and rear in the longitudinal direction, left and right in the lateral direction, and above and below in the vertical direction, respectively, of the vehicle, unless otherwise specified.

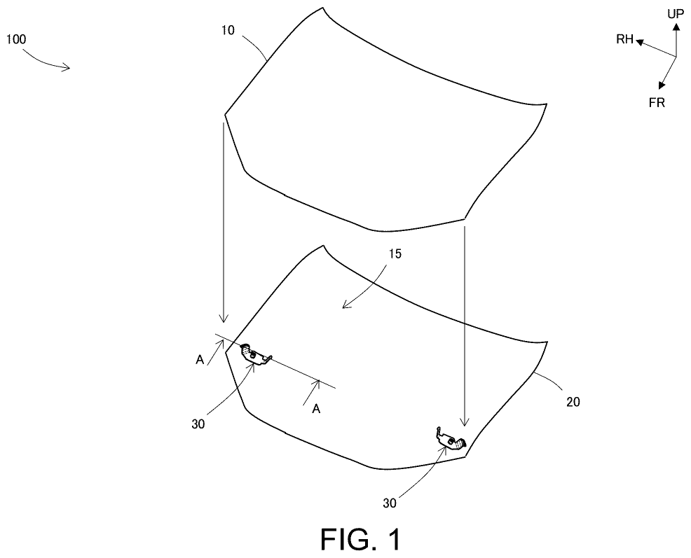

As illustrated in FIG. 1, the vehicle hood 100 includes an outer panel 10, an inner panel 20, and brackets 30 disposed in a space 15 between the outer panel 10 and the inner panel 20. A single bracket 30 is attached to each of right and left edges in a front portion of the inner panel 20. In the following examples, the bracket 30 disposed on the right side of the inner panel 20 will be described, and the bracket 30 disposed on the left side of the inner panel 20, which has a symmetrical configuration with respect to the bracket 30 on the right side, will not be described.

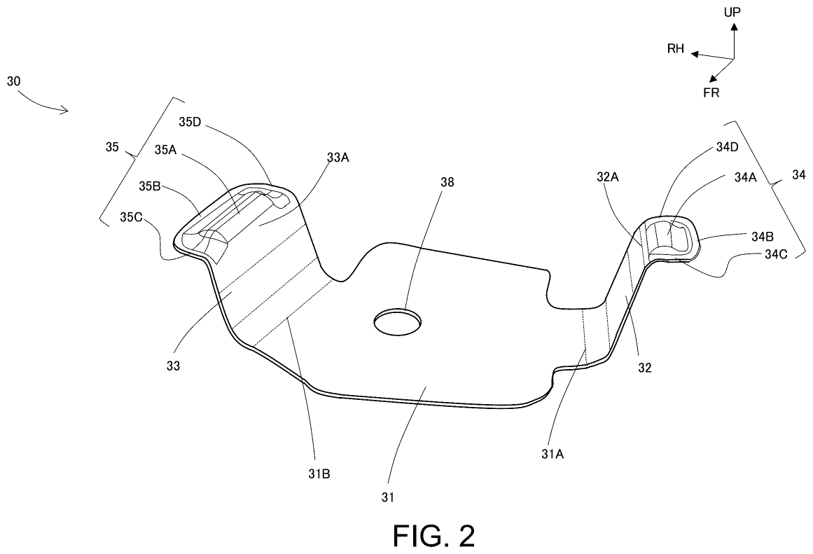

As illustrated in FIG. 2, the bracket 30 is a folded plate member having a hat-shape cross section, including a web 31, left and right flanges 32 and 33, and left and right arms 34 and 35. The left and right flanges 32 and 33 raise upward from left and right edges 31A and 31B of the web 31, respectively. The left and right arms 34 and 35 extend outward to the left and right from upper edges 32A and 33A of the left and right flanges 32 and 33, respectively.

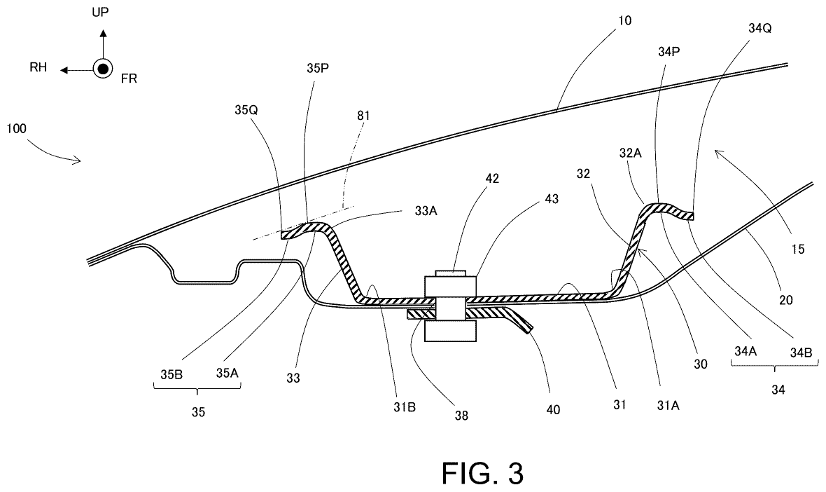

The right arm 35 includes a protrusion 35A, an outer edge portion 35B, a front edge portion 35C, and a rear edge portion 35D. As illustrated in FIG. 3, the protrusion 35A is an inverted U-shape portion extending outward from the upper edge 33A of the right flange 33. The outer edge portion 35B is a planar portion extending from a right outer edge of the protrusion 35A toward the right. Referring back to FIG. 2, the front edge portion 35C is a planar portion extending outward from the upper edge 33A at the front of the right flange 33. The rear edge portion 35D is a planar portion extending outward from the upper edge 33A at the rear of the right flange 33. As illustrated in FIG. 2, the outer edge portion 35B, the front edge portion 35C, and the rear edge portion 35D together form a single flat face. The protrusion 35A is bulged to protrude upward from this flat face.

The left arm 34, similar to the right arm 35, includes a protrusion 34A, an outer edge portion 34B, a front edge portion 34C, and a rear edge portion 34D. The left arm 34 has a symmetrical shape with respect to the right arm 35, except that the left arm 34 has a width in the front-rear direction that is slightly smaller than that of the right arm 35. The web 31 includes, in the center, a bolt hole 38 to allow insertion of a bolt 42 that secures a hardware piece 40.

As illustrated in FIG. 3, the bracket 30 is mounted on a top face of the inner panel 20 by welding such that the left and right arms 34 and 35 face the outer panel 10 and the outer edge portion 35B of the right arm 35 faces laterally outward. Further, a nut 43 is welded on the bolt hole 38 of the web 31. The hardware piece 40 is attached to the undersurface of the inner panel 20. The hardware piece 40 is secured to the undersurface of the inner panel 20 with the bolt 42, passing through a bolt hole (now shown) of the hardware piece 40 and the bolt hole 38 of the web 31 from the undersurface of the inner panel 20, screwed into the nut 43. The bolt 42 screwed into the nut 43 has a tip portion protruding from the top face of the web 31 toward the outer panel 10.

As illustrated in FIG. 3, in a state where the bracket 30 is mounted on the inner panel 20, a tangent 81, connecting an edge 35Q at a distal end on the right in the lateral direction on the top face of the outer edge portion 35B with a top face 35P of the protrusion 35A facing the outer panel 10 and extending laterally, is substantially parallel to the direction in which the outer panel 10 extends laterally.

In mounting the bracket 30 on the left side at the front of the inner panel 20, the bracket 30 is mounted in a symmetrical manner with respect to the bracket 30 mounted on the right side of the inner panel 20.

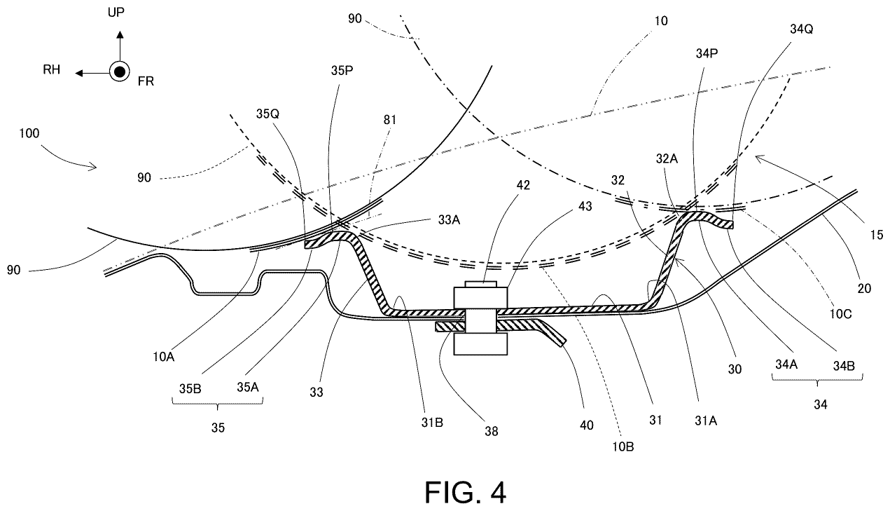

Referring to FIG. 4, contact between a head impactor 90 entering the vehicle hood 100 from above and the bracket 30 in a pedestrian protection test will be described.

In FIG. 4, a solid line shows approach of the head impactor 90 from a direction above a first position at the right edge portion of the vehicle hood 100. At this time, the head impactor 90 comes into contact with the edge 35Q of the bracket 30 and the top face 35P of the protrusion 35A through a first portion 10A of the outer panel 10, as indicated with the solid line. This allows an impulsive force caused by the impact of the head impactor 90 to be distributed between the edge 35Q and the protrusion 35A. This reduces a stress applied to the first portion 10A sandwiched between the edge 35Q and the head impactor 90, thereby preventing rupture of the first portion 10A. Prevention of rupture of the first portion 10A further prevents the edge 35Q from being exposed outside the outer panel 10 and prevents the head impactor 90 from contacting the bolt 42 or the nut 43 through the first portion 10A.

Further, the head impactor 90, when approaching a position slightly to the left of the first position, comes into contact with the top face 35P of the protrusion 35A through the first portion 10A before contacting the edge 35Q through the first portion 10A. After the right arm 35 and the flange 33 deform to absorb the impulsive force, the head impactor 90 contacts the edge 35Q through the first portion 10A. This reduces the stress applied to the first portion 10A sandwiched between the edge 35Q and the head impactor 90, thereby enabling inhibition of rupture of the first portion 10A.

The broken line in FIG. 4 indicates approach of the head impactor 90 from a direction above a second position further to the left of the vehicle with respect to the first position. At this time, the head impactor 90 comes into contact with top faces 34P and 35P of the respective protrusions 34A and 35A of the left and right arms 34 and 35 of the bracket 30, respectively, through a second portion 10B of the outer panel 10, as indicated by the broken line. This prevents left and right edges 34Q and 35Q from contacting the second portion 10B, thereby preventing exposure of the left and right edges 34Q and 35Q to outside the outer panel 10, and prevents the head impactor 90 from contacting the bolt 42 or the nut 43 through the second portion 10B.

The alternate long and short dashed lines in FIG. 4 indicate approach of the head impactor 90 from a direction above a third position located further left of the vehicle with respect to the second position. At this time, the head impactor 90 comes into contact with the top face 34P of the protrusion 34A of the left arm 34 of the bracket 30 through a third portion 10C of the outer panel 10, as indicated by the alternate long and short dashed lines. This prevents the left edge 34Q from contacting the third portion 10C, thereby preventing the left edge 34Q from being exposed to the outside of the outer panel 10. This also prevents the head impactor 90 from contacting the bolt 42 or the nut 43 through the third portion 10C.

As described above, the vehicle hood 100 is configured to allow the head impactor 90 to contact the protrusion 35A of the bracket 30 through the outer panel 10 simultaneously with or prior to the head impactor 90 contacting the outer edge portion 35B of the bracket 30 through the outer panel 10. This enables the vehicle hood 100 to distribute the stress generated in the outer panel 10 to thereby prevent rupture of the outer panel 10. The vehicle hood 100 can further prevent the edge 35Q of the outer edge portion 35B from being exposed to the outside.

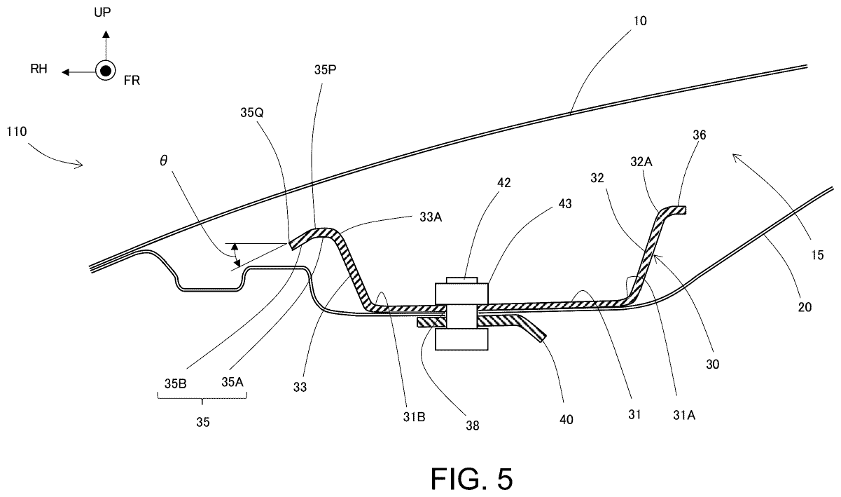

Referring now to FIG. 5, a vehicle hood 110 according to another embodiment will be described. Components of the vehicle hood 110 that are the same as those of the vehicle hood 100 described above by reference to FIGS. 1 to 4 are denoted with the same reference numerals and their description will not be repeated.

As illustrated in FIG. 5, in the vehicle hood 110, the right arm 35 of the bracket 30 is inclined downward of the vehicle as the right arm 35 extends toward the edge 35Q of the outer edge portion 35B. The angle of inclination θ in the diagonally downward direction may be greater than 0° and 40° or smaller.

In the vehicle hood 110, a left arm 36 is a planar member extending from the upper edge 32A of the left flange 32 toward the left.

The vehicle hood 110 described above includes the right arm 35 having the outer edge portion 35B with the edge 35Q that is inclined diagonally downward. This configuration enables the outer edge portion 35B to divert from the impacting direction of the head impactor 90 to thereby further distribute the stress generated in the outer panel 10 contacting the outer edge portion 35B to thereby prevent rupture of the outer panel 10.

Further, the left arm 36 composed of a planar member achieves a simple configuration of the bracket 30.

The vehicle hood 100 described above may include the left arm 34 having the outer edge portion 34B that is inclined downward of the vehicle as the left arm 34 extends toward the edge 34Q, similar to the outer edge portion 35B of the right arm 35. In this configuration, the angle of inclination θ in the diagonally downward direction may be greater than 0° and 40° or smaller.

While in the above examples, the bracket 30 is mounted on the right edge portion at the front of the inner panel 20 such that the outer edge portion 35B of the right arm 35 faces laterally outward of the vehicle, the present disclosure is not limited to this configuration. For example, the bracket 30 may be mounted on the right edge portion at the rear of the inner panel 20 such that the outer edge portion 35B of the right arm 35 faces laterally outward of the vehicle. Alternatively, the bracket 30 may be mounted in the center portion at the front of the inner panel 20 such that the outer edge portion 35B of the right arm 35 vehicle faces forward of the vehicle.

As described above, in mounting the bracket 30 on the left side of the inner panel 20, the bracket 30 is mounted in a symmetrical manner with respect to the bracket 30 mounted on the right side of the inner panel 20.

1. A vehicle hood comprising:
an outer panel;
an inner panel; and
a bracket disposed in a space between the outer panel and the inner panel, wherein
the bracket is a folded-plate member having a hat-shape cross section and including a web, two flanges rising from opposite ends of the web, and two arms respectively extending outward from corresponding upper edges of the respective flanges, the bracket being mounted on the inner panel such that each of the two arms faces the outer panel, and
at least one of the two arms includes a protrusion having an inverted U-shape and extending outward from the upper edge of the corresponding flange and an outer edge portion having a planar shape and extending outward from an outward edge of the protrusion.

2. The vehicle hood according to claim 1, wherein
a tangent connecting a distal end of the outer edge portion and a face of the protrusion facing the outer panel is substantially parallel to a direction in which the outer panel extends.

3. The vehicle hood according to claim 2, wherein
the outer edge portion is inclined downward of a vehicle as the outer edge portion extends toward the distal end.

4. The vehicle hood according to claim 3, wherein
the outer edge portion has an angle of inclination of greater than 0° and 40° or smaller.

5. A bracket mounted within a vehicle hood, comprising:
a web;
two flanges rising from opposite ends of the web; and
two arms respectively extending outward from corresponding upper edges of the respective flanges, wherein
the bracket is a folded-plate member having a hat-shape cross section, and
at least one of the two arms includes a protrusion having an inverted U-shape extending outward from the upper edge of the corresponding flange and an outer edge portion having a planar shape extending outward from an outward edge of the protrusion.
